(19) United States
(12) Patent Application Publication
(10) Pub. No.: US 2026/0338369 A1
(43) Pub. Date: Oct. 29, 2026

(54) LIGHT FIXTURE INCLUDING ENVIRONMENTAL INGRESS PROTECTION MEANS

(71) Applicant: SIGNIFY HOLDING B.V., EINDHOVEN (NL)

(72) Inventors: ALEXANDRE PLOMTEUX, MONTREAL (CA); SERGIO FABIAN JURDANA, BLAINVILLE (CA)

(21) Appl. No.: 19/106,350

(22) PCT Filed: Aug. 18, 2023
(86) PCT No.: PCT/EP2023/072768

§ 371 Date: Feb. 25, 2025

Related U.S. Application Data
(60) Provisional application No. 63/401,215, filed on Aug. 26, 2022.

(30) Foreign Application Priority Data
Sep. 8, 2022 (EP) 22194638.7

(51) Int. Cl. F21V 31/00; F21S 8/08; F21V 23/00; F21W 131/103; F21Y 105/12; F21Y 105/16; F21Y 115/10

(52) U.S. Cl. CPC F21V 31/005; F21S 8/086; F21V 23/002; F21V 23/009; F21W 2131/103; F21Y 2105/12; F21Y 2105/16; F21Y 2115/10

(57) ABSTRACT

A lighting fixture (100) is disclosed that includes an upper housing (101) that includes an electrical component (107) and a lower housing (102) that includes a lighting module (104) that is electrically coupled to the electrical component (107) using a wire positioned in a wire channel. A first seal (200) including a wire pathway (201) and a slit (202) can be positioned with a first orientation in the wire channel (110) and allow the wire to pass there through using the wire pathway (201) and the slit (202). When the first seal (200) is positioned with the first orientation in the wire channel (110) the possibility of water penetration into one or both of the upper housing (101) or the lower housing (102) via the wire channel (110) is reduced. The first seal (200) can be positioned with a second orientation in the wire channel (110) so that the wire pathway (201) is perpendicular to the wire channel (110) when no wire is needed. The lighting fixture (100) may also include a wire tunnel (109) formed between the upper housing (101) and the lower housing (102) and including an aperture (111) at one end through which the wire passes there through. A second seal can be positioned in the aperture (111) and allow the wire to pass there through the aperture (111). The wire is compressed between a side of the second seal (300) and the aperture (111).

### FIELD OF THE INVENTION

The invention relates to generally to lighting fixtures, and in particular, to an outdoor lighting fixture including environmental ingress protection using seals.

### BACKGROUND

Sealing of lighting devices from environmental (e.g., water and dust) ingress is important for reliability and safety reasons. When electrified devices are exposed to the outdoor and the elements there can be a safety risk if water makes it way to exposed electrical junctions. Preventing water from entering the device and exposing the internal electrical devices is achieved by different methods. For lighting fixtures, ingress protection must meet various safety standards such as the UL 1598 standard and ANSI C136.

When considering installing an outdoor luminaire that requires a strong waterproof ability such luminaires normally have IP65 or IP66 ratings. International Electrotechnical Commission (IEC) publishes IP (Ingress Protection) codes, describing the amount of water and dust that a mechanical casing or electrical enclosure can withstand, among other protective capabilities. An outdoor luminaire has electrical connections and electronic devices inside an IP66 or IP65 housing that cannot be exposed to water droplets. A luminaire with IP66 waterproof level is able to withstand water with high-pressure during testing as well as in real life conditions. If the luminaire can be separated into subparts i.e., a main body from a lighting LED module, or can have various configurations, i.e., the number of lighting LED modules, this requires that all seals between the housing and the lighting LED modules are also IP rated.

Configurable luminaires are typically required for outdoor environmental lighting, including, for example, streetlamps, parking lighting, pathway lighting, and so forth. Such luminaires may be configured with various constructions (i.e., scalable) to provide different light distribution in accordance with various codes and requirements. Also, based on the applications, different mounting requirements may be involved.

Environmental protection is particularly important for high mast light fixtures. Such fixtures are raised high to minimize ground level obstructions and create uniform illumination across a large area. The high mounting height combined with a multiple-luminaire configuration makes high mast luminaires the most efficient and effective way of illuminating large areas. Such high mast luminaires must possess the strength and resistance required to survive the most challenging outdoor environments.

Conventional high mast luminaires include three main sub-assemblies: mast structure, headframe, and lighting module. The headframe can be further divided into the fixed and mobile types. In a system with a mobile headframe, the mast structure has a winch mechanism which allows the headframe to be lowered to ground level for maintenance. The mobile headframe comes with a latching mechanism that holds the entire weight of the headframe. The mobile and the fixed headframe can be configured to include one or more lighting modules to provide different light distribution as required for the particular application. However, in such conventional high mast luminaires, one potential shortcoming is that water, dust, etc., may enter the headframe and lighting module and cause damage if the connection points (both mechanical and electrical connection points) are not properly protected from such environmental factors.

### SUMMARY OF THE PRESENT INVENTION

Aspects, objects, and embodiments of the present invention address the shortcomings discussed above.

In this regard, one aspect of the present invention allows for a sealing device that may use a combination of two seals that can be combined in various configurations to achieve an IP66 and/or IP65 rating. A first seal may include a pressure relief function, and a second seal includes a lower pressure relief function. The first seal and the second seal may work independently or in combination. In particular, the first seal serves as a pressure relief to prevent water from penetrating to internal compartments by reducing the water pressure and stopping water jets from penetrating by force beyond this first seal barrier. In other configurations, the second seal may be used in combination to the first seal to prevent water ingress from penetrating connecting wire ways between, for example, a lower and an upper housings or between the headframes and lighting modules.

Yet another aspect of the present inventions allows for seal components to serve two different situations. In the first situation, when there is a need for one or more electric wires to pass through a wire passage to establish an election connection, the seal components can be installed parallel to the one or more wires in the wire passage. In the second situation, when no wires are present or required, the seal components are installed in the wire passage in a 90 degree orientation from the wire channel to completely seal the wire passage. In this regard, aspects of the present invention allow for sealing of a lower part of a luminaire housing to prevent water ingress to makes its way to an upper part of the luminaire housing by removing water velocity and water pressure.

Proposed embodiments may therefore be used to seal electrical or mechanical connection points in housing compartments to prevent ingress of foreign contaminants from possibly damaging electrical components or circuitry.

One embodiment of the present invention is directed to a lighting fixture that includes an upper housing and a lower housing. The upper housing includes an electrical component and the lower housing includes a lighting module that is electrically coupled to the electrical component using a wire disposed in a wire channel. A first seal has a wire pathway and a slit can be positioned with a first orientation in the wire channel and allow the wire to pass there through using the wire pathway and the slit. When the first seal is positioned with the first orientation in the wire channel the possibility of water penetration into one or both of the upper housing or the lower housing via the wire channel is reduced. The first seal can be positioned with a second orientation in the wire channel so that the wire pathway is perpendicular to the wire channel when no wire is needed. The lighting fixture may also include a wire tunnel formed between the upper housing and the lower housing and including an aperture at one end through which the wire passes there through. A second seal can be positioned in the aperture and allow the wire to pass there through the aperture. The wire is compressed between a side of the second seal and the aperture.

Another embodiment of the present invention is directed to a lighting fixture a housing that includes an electrical component and a lighting module that is electrically coupled to the electrical component using a wire positioned in a wire channel. A first seal including a wire pathway and a slit that can be positioned with a first orientation in the wire channel and allow the wire to pass there through using the wire pathway and the slit. When the first seal is positioned with the first orientation in the wire channel, the possibility of water penetration into the housing via the wire channel is reduced. The first seal can be positioned with a second orientation in the wire channel so that the wire pathway is perpendicular to the wire channel.

In another embodiment, the lighting fixture also includes a wire tunnel formed between the electrical component and the lighting module that includes an aperture at one end through which the wire passes there through. A second seal can be disposed in the aperture to allow the wire to pass there through the aperture. The wire is compressed between a side of the second seal and the aperture.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the figures, elements which correspond to elements already described may have the same reference numerals. In the drawings,

FIGS. 1a and 1b illustrates perspectives views of an example light-emitting diode based lighting fixture, in accordance with an example embodiment of the present disclosure;

FIG. 2 illustrates perspectives views of an example light-emitting diode based lighting fixture configured with a plurality of LED modules, in accordance with an example embodiment of the present disclosure;

FIG. 3 illustrates a cross-sectional view of an example light-emitting diode based lighting fixture in accordance with certain example embodiments;

FIG. 4 illustrate a detail of a first seal in accordance with certain example embodiments;

FIG. 5 illustrate a detail of a second seal in accordance with certain example embodiments;

FIG. 6 illustrate the first seal inserted in the example light-emitting diode based lighting fixture in accordance with certain example embodiments;

FIGS. 7a and 7b illustrate the second seal inserting and not inserted in the example light-emitting diode based lighting fixture in accordance with certain example embodiments.

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

In the following paragraphs, the present disclosure will be described in further detail by way of examples with reference to the attached drawings. In the description, well known components, methods, and/or processing techniques are omitted or briefly described so as not to obscure the disclosure. As used herein, the “present disclosure” and/or “present invention” refers to any one of the embodiments of the disclosure described herein and any equivalents. Furthermore, reference to various feature(s) of the “present disclosure” is not to suggest that all embodiments must include the referenced feature(s).

The example embodiments discussed herein are directed to high mast luminaires such as the luminaires mounted above roadways. While the example embodiments described herein are in the context of high mast luminaires, it should be understood that the embodiments described herein can apply to a variety of luminaires. For example, the embodiments can be used with luminaires located in any environment (e.g., indoor, outdoor, hazardous, non-hazardous, high humidity, low temperature, corrosive, sterile, high vibration). Further, the luminaires described herein can use one or more of a number of different types of light sources, including but not limited to various light-emitting diode (LED) light sources such as discrete LEDs, LED arrays, chip on board LEDs, and organic LED light sources, as well as other types of light sources. Therefore, the example luminaires described herein, should not be considered limited to a particular type of light source.

In certain example embodiments, the example luminaires are subject to meeting certain standards and/or requirements. For example, the National Electric Code (NEC), the National Electrical Manufacturers Association (NEMA), the International Electrotechnical Commission (IEC), the Federal Communication Commission (FCC), and the Institute of Electrical and Electronics Engineers (IEEE) set standards as to electrical enclosures (e.g., light fixtures), wiring, and electrical connections. As another example, Underwriters Laboratories (UL) sets various standards for light fixtures, including standards for heat dissipation. Use of example embodiments described herein meet (and/or allow a corresponding device to meet) such standards when required.

Any luminaires, or components thereof (e.g., housings), described herein can be made from a single piece (e.g., as from a mold, injection mold, die cast, 3-D printing process, extrusion process, stamping process, or other prototype methods). In addition, or in the alternative, a luminaire (or components thereof) can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, and slotted fittings. One or more pieces that are mechanically coupled to each other can be coupled to each other in one or more of a number of ways, including but not limited to fixedly, hingedly, removably, slidably, and threadably.

A coupling feature (including a complementary coupling feature) can allow one or more components and/or portions of an example housing or other component of a light fixture to become coupled, directly or indirectly, to another portion of the example housing or other component of a light fixture. A coupling feature can include, but is not limited to, a snap, Velcro, a clamp, a portion of a hinge, an aperture, a recessed area, a protrusion, a slot, a spring clip, a tab, a detent, and mating threads. One portion of an example housing can be coupled to a light fixture by the direct use of one or more coupling features.

In addition, or in the alternative, a portion of a luminaire can be coupled using one or more independent devices that interact with one or more coupling features disposed on a component of the housing. Examples of such devices can include, but are not limited to, a pin, a hinge, a fastening device (e.g., a bolt, a screw, a rivet), epoxy, glue, adhesive, tape, and a spring. One coupling feature described herein can be the same as, or different than, one or more other coupling features described herein. A complementary coupling feature (also sometimes called a corresponding coupling feature) as described herein can be a coupling feature that mechanically couples, directly or indirectly, with another coupling feature.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

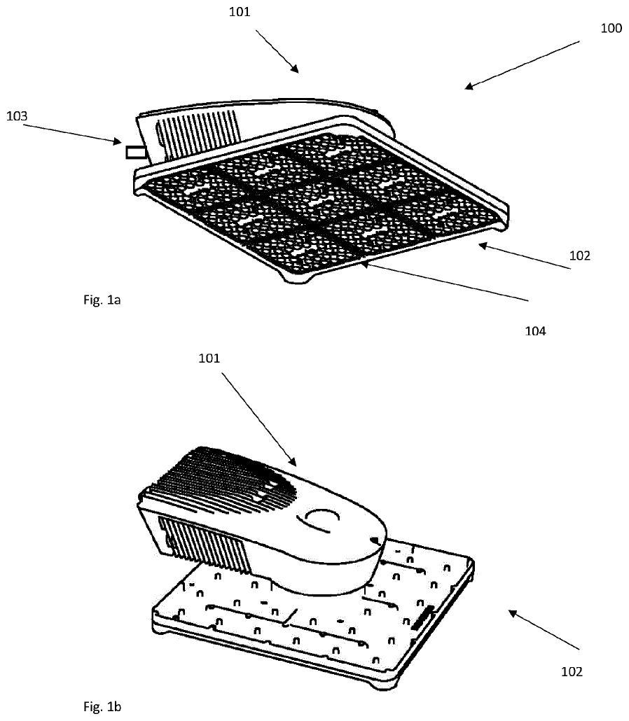

Referring to FIGS. 1a and ab, perspective bottom and top views of an example luminaire 100 are shown. The example luminaire 100 includes an upper housing 101 connected to a lower housing 102. The luminaire 100 may be attached to a pole 103 for mounting, for example, above a roadway.

The luminaire 100 may provide a scalable, variable configurable lighting using one or more lighting modules 104 as shown in FIG. 1a. The luminaire 100 may utilizes a “mix and match” type system of different sets of the lighting modules 104 to meet a plurality of different lighting requirement. The lighting modules 104 may be varied in light output and features. Preferably, the lighting modules 104 are sealed to provide IP66 level ingress protection against water and dust penetration. The lighting modules 104 may be mechanically coupled to the lower housing 102 via a couple feature as discussed above.

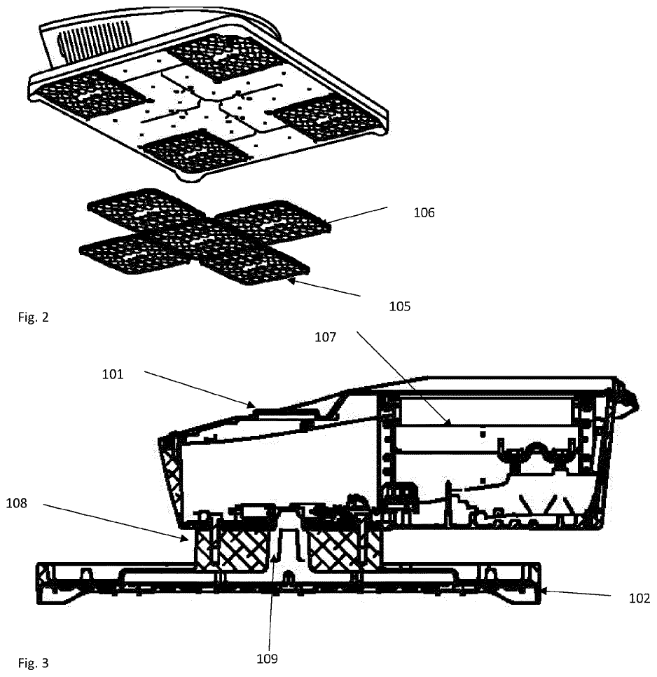

In the example embodiments of FIGS. 2 and 3b, the lighting modules 104 are LED light modules 104 which includes a base 105 to which is affixed a plurality of LED light elements 106 disposed to generate light outwardly from the LED lighting module 104. Any type of LED light elements 106 which are electrically powered to generate light may be utilized. The LED light elements 106 are powered by one or more drivers (not shown) which may be provided in the upper housing 101 (as shown) or in the lower housing 102. As is known in the art, the driver(s) is each configured to convert alternating current to direct current to power the LED light elements 106. Lenses or other optics may be provided with each of the LED lighting modules 105 to diffuse or otherwise act on light generated by the LED light elements 106.

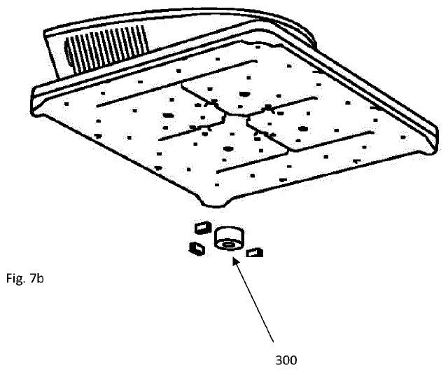

As shown in example FIGS. 2 and 7a, a choice of 2-9 LED lighting modules 105 may be used which enable lighting designers to make optimal configurations. Each of the lighting modules 105 may include high performance LEDs with correlated color temperature. The lower housing 102 including the lighting modules 105 may be rotatable, allowing for precision asymmetric distribution.

FIG. 3 illustrates a cross-sectional view of the example luminaire 100. As noted above shown, the upper housing 102 may include the one or more drivers. The upper housing 102 may include a variety of other electronic components 107 such as dimming controls, digital wireless control systems and surge protection circuitry. Such electronic components 107 must be protected from elemental factors such as water and dust penetration.

As shown in FIG. 3, one or more coupling features 108 connect the lower housing 102 to the upper housing 101. In addition, one or more wiring tunnels 109 may be used to provide a pathway for electrical wires to electrically couple the lighting modules 105 to the electronic components 107, as may be needed, in the upper housing 101. The coupling features 108 and/or the wiring tunnel 109 must not allow, for example, water to penetrate into the upper housing 101 or the lower housing 102.

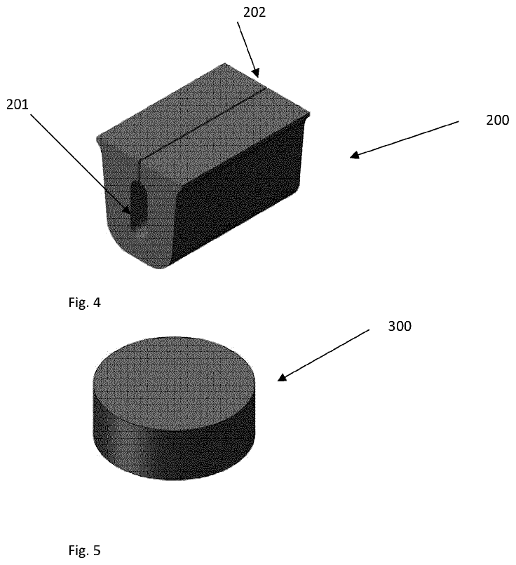

FIGS. 4 and 5 illustrate details of a first seal 200 and a second seal 300 in accordance with certain example embodiments to prevent or reduce possible water penetration into the upper housing 101 or the lower housing 102. The first seal 200 and the second seal 300 may be made from and/or lined with silicone and/or rubber and/or other waterproof/resistant materials. Other such waterproof material that may be used include polyurethane, cementitious coating EPDM Rubber, thermoplastic, bituminous membrane, waterproof/resistant fabrics and materials such as styrofoam. In one embodiment, the first seal 200 and the second seal 300 should have some flexibility or compressibility to allow it to be inserted/mated in an aperture so that it fit in a tight or confirming manner in the aperture. In other embodiments, the first seal 200 and the second seal 300 are formed from a semi-rigid material and sized to fit tightly in an aperture. In another embodiment, the first seal 200 and the second seal 300 are designed to fit in the aperture in a plug or bottle-cork like manner.

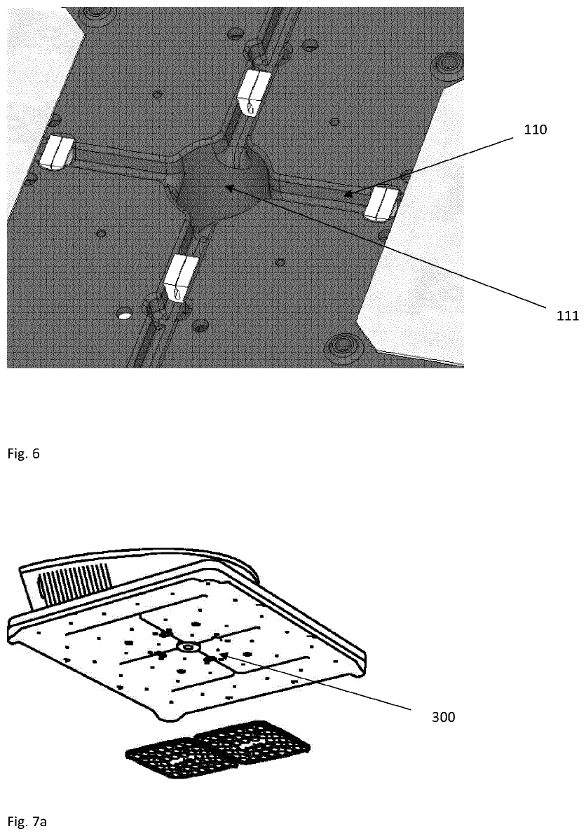

As shown in FIG. 4, the first seal 200 may have a U-shape to enable the first seal 200 to be removably inserted/mated to one or more wiring channels 110 (shown in FIG. 6). The first seal 200 may have other shaped to accommodate other configurations/shapes to insert/mate to a corresponding configurations/shapes of the wiring channel 110. For example, the cross-sectional shape of the first seal 200 may also comprise a U-shape, circular, rectangular, pentagonal, hexagonal, elliptical, or octagonal cross-section, or other cross-section. The first seal 200 includes a wire pathway 201 to allow electrical wires to pass through the first seal 200. The electrical wires may be inserted into the wire pathway 201 via a slit 202 at the top of first 200. When the first seal 200 is inserted/mated to the wiring channel 110 pressure is exerted on the outer sides of the first seal 200 so that the slit is forced closed to prevent/reduce the possibility of water penetration.

As shown in FIG. 6, the first seal 200 by inserted/mated to the wiring channel 110 in two different positions/orientations. In the first position, the wire pathway 201 is parallel to the wiring channel 110. In the second position, the wire pathway 201 is perpendicular to the wiring channel 110. The perpendicular position may be used when no electrical wires need to be passed through the first seal 200. In the perpendicular position, the length of the first seal 200 is designed to fit tightly in the wiring channel 110 to prevent/reduce the possibility of water penetration.

As shown in the embodiment of FIG. 5, the second seal 300 may have a circular, disk-like shape and made from a semi-flexible material. However, it should be understood that other shapes may be used. For example, the cross-sectional shape of the second seal 300 may also comprise a circular, rectangular, pentagonal, hexagonal, elliptical, or octagonal cross-section, or other cross-section. The shape of the second seal 300 is designed to match an aperture 111 formed at one end of the wiring tunnel 109 and used to allow for the electrical wires to pass though the wiring tunnel 109 between the upper housing 101 and the lower housing 102. The second seal 300 is removably inserted/mated to the aperture 111 as shown in FIG. 7a or removed as shown in FIG. 7b. When inserted/mated to the aperture 111, the second seal 300 forms a seal between the sides of the second seal 300 and the aperture 111 while allowing a wire to pass through the aperture 111. The wire being compressed between the side of the second seal 300 and the aperture 111.

The second seal 300 may be used alone or as an additional water protection after the first seal 200. In this regard, the first seal 200 can serves as a pressure relief to prevent water to penetrate this first barrier by reducing the water pressure and stopping a water jet from penetrating by force beyond the first seal 200. The second seal 300 may be used in conjunction with the first seal to prevent water ingress from penetrating into the central connecting wire way (i.e., the wiring tunnel 109) way between the lower housing 102 and the upper housing 101 if any water were able to penetrate the first seal 200.

As shown if FIGS. 6, 7a and 7b, the first seal 200 and the second seal 300 may be removed and reused as needed to allow for maintenance or repair of the luminaire 100.

The foregoing detailed description has set forth a few of the many forms that the invention can take. The above examples are merely illustrative of several possible embodiments of various aspects of the present invention, wherein equivalent alterations and/or modifications will occur to others skilled in the art upon reading and understanding of the present invention and the annexed drawings. In particular, regard to the various functions performed by the above described components, the terms (including a reference to a “means”) used to describe such components are intended to correspond, unless otherwise indicated to any component, such as hardware or combinations thereof, which performs the specified function of the described component (i.e., that is functionally equivalent), even though not structurally equivalent to the disclosed structure which performs the function in the illustrated implementations of the disclosure.

Although a particular feature of the present invention may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”.

The present invention has been described with reference to the preferred embodiments. However, modifications and alterations will occur to others upon reading and understanding the preceding detailed description. It is intended that the present invention be construed as including all such modifications and alterations. It is only the claims, including all equivalents that are intended to define the scope of the present invention.

In the claims references in parentheses refer to reference signs in drawings of exemplifying embodiments or to formulas of embodiments, thus increasing the intelligibility of the claim. These references shall not be construed as limiting the claim.

1. A lighting fixture, comprising:
an upper housing that includes an electrical component;
a lower housing that includes a lighting module that is electrically coupled to the electrical component using a wire positioned in a wire channel;
a first seal including a wire pathway and a slit that can be positioned with a first orientation in the wire channel and allow the wire to pass there through using the wire pathway and the slit,
wherein when the first seal is positioned with the first orientation in the wire channel the possibility of water penetration into one or both of the upper housing or the lower housing via the wire channel is reduced, and wherein the first seal can be positioned with a second orientation in the wire channel so that the wire pathway is perpendicular to the wire channel,
wherein the first seal is positioned with the second orientation in the wire channel the possibility of water penetration into one or both of the upper housing or the lower housing is reduced.

2. The lighting fixture of claim 1, wherein the first seal and/or the second seal is made from and/or lined with silicone and/or rubber and/or other waterproof/resistant material.

3. The lighting fixture of claim 1, wherein the first seal can be removably positioned in the wiring channel and/or the second seal can be removably positioned in the aperture.

4. The lighting fixture of claim 1, wherein when the first seal is positioned in the wiring channel pressure is exerted on an outer side of the first seal so that the slit is forced closed to reduce the possibility of water penetration into the slit.

5. The lighting fixture of claim 1, wherein the first seal is shaped to accommodate a corresponding shape of the wiring channel and/or the second seal is shaped to accommodate a corresponding shape of the aperture.

6. The lighting fixture of claim 5, wherein the first seal is from a material that is compressible to allow the first seal to be positioned in the wire channel in a confirming manner.

7. The lighting fixture of claim 5, wherein the first seal is made from a semi-rigid material so allow the first seal to be positioned tightly in the wire channel using pressure.

8. The lighting fixture of claim 5, wherein the first seal is designed to be positioned in the wire channel in a plug or bottle-cork like manner.

9. The lighting fixture of claim 5, wherein the first seal has a cross-sectional shape that is U-shaped, circular, rectangular, pentagonal, hexagonal, elliptical, or octagonal.

10. The lighting fixture of claim 1, further including:
a wire tunnel formed between the upper housing and the lower housing and including an aperture at one end through which the wire passes there through; and
a second seal that can be positioned in the aperture and allow the wire to pass there through the aperture, the wire being compressed between a side of the second seal and the aperture.

11. The lighting fixture of claim 10, wherein the second seal has a cross-sectional shape that is circular, rectangular, pentagonal, hexagonal, elliptical, or octagonal.
